(19) United States
(12) Patent Application Publication
(10) Pub. No.: US 2015/0355220 A1
(43) Pub. Date: Dec. 10, 2015

(54) INERTIAL SENSOR MODULE HAVING HERMETIC SEAL FORMED OF METAL AND MULTI-AXIS SENSOR EMPLOYING THE SAME

(71) Applicant: SAMSUNG ELECTRO-MECHANICS CO., LTD., Suwon-si (KR)

(72) Inventors: Pil Joong KANG, Suwon-si (KR); Jung Won LEE, Suwon-si (KR); Hyun Kee LEE, Suwon-si (KR); Jong Hyeong SONG, Suwon-si (KR)

(73) Assignee: SAMSUNG ELECTRO-MECHANICS CO., LTD., Suwon-si (KR)

(21) Appl. No.: 14/690,839

(22) Filed: Apr. 20, 2015

(30) Foreign Application Priority Data
Jun. 10, 2014 (KR) 10-2014-0070116

(51) Int. Cl. G01P 15/12; G01P 15/093; G01P 15/125; G01P 15/02

(52) U.S. Cl. CPC G01P 15/123; G01P 15/02; G01P 15/093; G01P 15/125

(57) ABSTRACT

There are provided an inertial sensor module having a hermetic seal formed of metal and a multi-axis sensor employing the same. The inertial sensor module includes: a sensor main body including a plurality of wirings connected to any one of a driving electrode of a sensor and a sensing electrode of the sensor and formed on a substrate for a lower cap by a wafer level package (WLP) scheme to detect an inertial force; a substrate for an upper cap bonded on the sensor main body to protect the sensor main body; and a hermetic seal formed of metal isolated from the wiring and interposed into the sensor main body and the substrate for the upper cap by performing the bonding by metal bonding.

### CROSS-REFERENCE TO RELATED APPLICATION

This application claims the benefit of Korean Patent Application No. 10-2014-0070116, filed on Jun. 10, 2014, entitled “Inertial Sensor Module Having Hermetic Seal Formed Of Metal And Multi-Axis Sensor Employing The Same” which is hereby incorporated by reference in its entirety into this application.

### BACKGROUND

The present disclosure relates to an inertial sensor module having a hermetic seal formed of metal and multi-axis sensor employing the same.

Electronic parts included in mobile electronics such as a mobile phone and a tablet PC has two important goals (competitive goal). One goal is to reduce a size of the electronic parts while making performance of the electronic parts the same or more excellent. The other goal is to minimize power consumption.

Electronic parts, in particular, various sensors such as an angular velocity sensor, an acceleration sensor, an earth magnetic field sensor, and a pressure sensor measure a variety of information and provide the measured information as described in the following Korean Patent No. 10-0855471.

As described above, each information of various sensors may be used as information required for functions of the mobile electronics but to provide more various and complicated functions to users of the mobile electronics, since the information of various sensors is used as the information required for the functions of the mobile electronics only when being calculated overall, a use of a multi-axis sensor in which various sensors are integrated is increasingly growing recently.

Further, a demand for a method for appropriately designing and manufacturing a multi-axis sensor capable of reducing power consumption using a method for determining various sensors using a single integrated information processing device, obtaining information by driving only the required sensor when necessary, and the like tends to be increased.

### RELATED ART DOCUMENT

### Patent Document

(Patent Document 1) KR10-0855471 B

SUMMARY

An aspect of the present disclosure may provide an inertial sensor module having a hermetic seal formed of metal and multi-axis sensor employing the same by improving structures of the inertial sensor module and the multi-axis sensor employing the same to be able to implement miniaturization and reduce power consumption.

According to an aspect of the present disclosure, an inertial sensor module may include: a sensor main body including a plurality of wirings connected to any one of a driving electrode of a sensor and a sensing electrode of the sensor and formed on a substrate for a lower cap by a wafer level package (WLP) scheme to detect an inertial force; a substrate for an upper cap bonded on the sensor main body to protect the sensor main body; and a hermetic seal formed of metal isolated from the wiring and interposed into the sensor main body and the substrate for the upper cap by performing the bonding by metal bonding.

The substrate for the lower cap may include an electrical wiring formed in horizontal/vertical directions and is formed of a material implementing hermetic seal bonding.

The substrate for the lower cap may be formed of any one of low temperature co-fired ceramic (LTCC), glass, interposer, application specific integrated circuit (ASIC), and silicon.

The substrate for the upper cap and the substrate for the lower cap may be each formed of ASIC.

The sensor main body may include a 3-axis acceleration sensor and a 3-axis angular velocity sensor.

The sensor main body may include: a first pad formed on the sensor main body of the bonded portion and connected to a distal end of the wiring; and a second pad formed on the sensor main body of the bonded portion, being spaced apart from the first pad.

The substrate for the upper cap may include: a bridge electrode formed within a lower portion of the substrate for the upper cap of the bonded portion; and a bridge insulating pattern formed in a predetermined area on the bridge electrode to expose both ends of the bridge electrode, wherein the bridge electrode may intersect with the hermetic seal formed of metal and may be insulated by the bridge insulating pattern.

The sensor main body may include a first pad connected to a distal end of the wiring and a second pad formed to be spaced apart from the first pad and the bridge electrode and the first and second pads may be connected to each other by having a metal bonding sheet used for the metal bonding interposed therebetween.

The hermetic seal formed of metal may be a stacked structure of a metal pattern formed on the sensor main body of the bonded portion and a metal bonding sheet used for the metal bonding.

The hermetic seal formed of metal may be interposed into the sensor main body and a bridge insulating pattern between the first and second pads.

According to another aspect of the present disclosure, a multi-axis sensor which is a 9-axis sensor including: a PCB, a 6-axis inertial sensor module bonded on the PCB to sense an inertial force, and a 3-axis earth magnetic field sensor bonded on the 6-axis inertial sensor module to sense a position, and the 6-axis inertial sensor module may include: a sensor main body including a plurality of wirings connected to any one of a driving electrode of a sensor and a sensing electrode of the sensor and formed on a substrate for a lower cap by a WLP scheme to detect an inertial force; a substrate for an upper cap bonded on the sensor main body to protect the sensor main body; and a hermetic seal formed of metal isolated from the wiring and interposed into the sensor main body and the substrate for the upper cap by performing the bonding by metal bonding.

The substrate for the lower cap may include an electrical wiring formed in horizontal/vertical directions and may be formed of a material implementing hermetic seal bonding.

The substrate for the upper cap and the substrate for the lower cap may be each formed of ASIC.

The 3-axis earth magnetic field sensor may be formed by a single-in-line package (SIP) scheme.

The sensor main body may include: a first pad formed on the sensor main body of the bonded portion and connected to a distal end of the wiring; and a second pad formed on the sensor main body of the bonded portion, being spaced apart from the first pad.

The substrate for the upper cap may include: a bridge electrode formed within a lower portion of the substrate for the upper cap of the bonded portion; and a bridge insulating pattern formed in a predetermined area on the bridge electrode to expose both ends of the bridge electrode, wherein the bridge electrode may intersect with the hermetic seal formed of metal and may be insulated by the bridge insulating pattern.

The sensor main body may include a first pad connected to a distal end of the wiring and a second pad formed to be spaced apart from the first pad and the bridge electrode and the first and second pads may be connected to each other by having the metal bonding sheet used for the metal bonding interposed therebetween.

The hermetic seal formed of metal may be a stacked structure of a metal pattern formed on the sensor main body of the bonded portion and a metal bonding sheet used for the metal bonding.

The hermetic seal formed of metal may be interposed into the sensor main body and a bridge insulating pattern between the first and second pads.

5

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a plan view illustrating an inertial sensor module according to an exemplary embodiment of the present disclosure;

FIG. 2 is a cross-sectional view illustrating an angular velocity sensor in side ‘A’ of FIG. 1;

FIG. 3 is a graph illustrating transmittance depending on materials;

FIG. 4 is a diagram illustrating a hermetic seal and an electrode pad of FIG. 2;

FIG. 5 is an enlarged cross-sectional view of region “B” of FIG. 2;

FIG. 6 is a cross-sectional view illustrating a hermetic seal and an electrode pad of an angular velocity sensor according to another exemplary embodiment of the present disclosure;

FIG. 7 is a cross-sectional view illustrating a 6-axis sensor according to an exemplary embodiment of the present disclosure;

FIG. 8 is a plan view illustrating a 9-axis sensor according to an exemplary embodiment of the present disclosure;

FIG. 9 is a cross-sectional view illustrating an angular velocity sensor and an earth magnetic field sensor in side ‘C’ of FIG. 8;

FIG. 10 is a view illustrating a method for forming an inertial sensor module according to an exemplary embodiment of the present disclosure; and

FIGS. 11A and 11B are cross-sectional views of a method for forming a hermetic seal and an electrode pad of FIG. 10.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

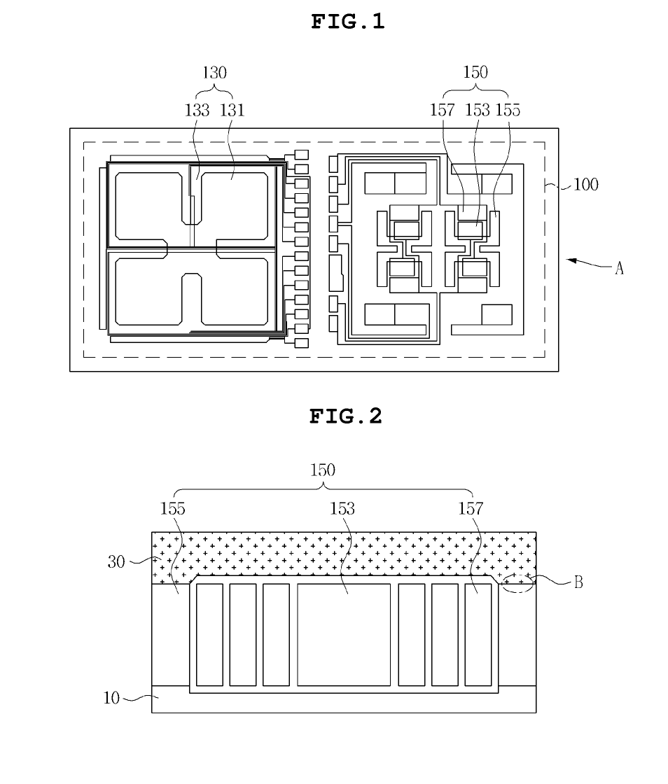

FIG. 1 is a plan view illustrating an inertial sensor module according to an exemplary embodiment of the present disclosure and FIG. 2 is a cross-sectional view illustrating an angular velocity sensor in side ‘A’ of FIG. 1.

As illustrated in FIGS. 1 and 2, an inertial sensor module 100 according to an exemplary embodiment of the present disclosure includes a 3-axis acceleration sensor 130 and a 3-axis angular velocity sensor 150 which are formed on a substrate 10 for a lower cap by a WLP scheme.

The substrate 10 for the lower cap is a substrate which may have electrical wirings formed thereon in a horizontal/vertical direction and have hermetic seal bonding performed thereon and may be formed of LTCC, glass, interposer, ASIC provided with a through hole, silicon provided with vertical/horizontal wirings, and the like.

The acceleration sensor 130 is a 3-axis sensor including a substrate 30 for an upper cap to measure accelerations of X, Y, and Z axes to sense a straight motion. The acceleration sensor 130 needs to be high resolution and miniaturized to detect a fine acceleration.

For example, the acceleration sensor 130 includes a mass body 131 and a flexible beam 133 connected to the mass body 131 to convert a motion of the mass body 131 or the flexible beam 133 into an electrical signal.

That is, when an acceleration is applied to the acceleration sensor 130 by an external force, the acceleration sensor 130 may extract a potential difference occurring due to a difference in variations of resistance of four piezo-resistance elements (not illustrated) which detect accelerations of each mass body 131 by changing electrical resistance of the piezo-resistance elements mounted in the flexible beams 133 in response to a displacement of the mass bodies 131 and the flexible beams 133 Further, the acceleration sensor 130 may include wirings (not illustrated) which electrically connect the flexible beam 133 to the piezo resistance elements.

Here, the flexible beam 133 supports the mass body 131 and first to fourth flexible beams each are formed at centers of each side around the mass bodies 131.

For example, an end of the first flexible beam is provided with a semiconductor piezo resistance element for X-axis acceleration detection and an end of the second flexible beam is provided with a semiconductor piezo resistance element for Z-axis acceleration detection, such that the first flexible beam and the second flexible beam may detect accelerations in the X-axis and Z-axis directions. Further, the third flexible beam and the fourth flexible beam vertically disposed to the first flexible beam and the second flexible beam are each provided with a semiconductor piezo resistance element for Y-axis acceleration detection to be able to detect an acceleration in the Y-axis direction.

The angular velocity sensor 150 is a 3-axis sensor including the substrate 30 for the upper cap to measure angular velocity of X, Y, and Z axes to sense an angle motion. The angular velocity sensor 150 needs to be high resolution and miniaturized to detect a fine angular velocity.

For example, the angular velocity sensor 150 includes a sensor mass body 153, a frame 155, and a flexible part 157.

The sensor mass body 153 is displaced due to a Coriolis force and includes a first mass body and a second mass body which are formed to have the same size and shape. The first and second mass bodies are illustrated to have a square pillar shape as a whole but are not limited thereto, and therefore the first and second mass bodies may be formed to have all shapes known in the art.

Further, the flexible parts 157 each connected to the first and second mass bodies are connected to the frames 155, respectively and thus the first and second mass bodies are supported to the frames 155. To this end, the frame 155 may have the sensor mass body 153 embedded therein and is connected to the sensor mass body 153 by the flexible part 157.

The frame 155 secures a space in which the first and second mass bodies connected to each other by the flexible part 157 may each be displaced and becomes a reference when the first and second mass bodies are displaced. Further, the frame 155 may be formed at the same thickness as the flexible part 157.

Further, the frame 155 may also be formed to cover only a portion of the mass body part 153. Further, the frame 155 may have a square pillar shape in which it has a square pillar shaped cavity formed at the center thereof, but is not limited thereto.

Further, the flexible part 157 may be provided with a sensing unit which senses a displacement of an angle of the sensor mass body 153. Further, the flexible part 157 may be separately disposed at a position remote from a center of the sensor mass body 153 by a predetermined distance to measure a vibration displacement of the sensor mass body 153. Here, the sensing unit is not particularly limited, but may be formed to use a piezoelectric type, a piezoresistive type, a capacitive type, an optical type, and the like.

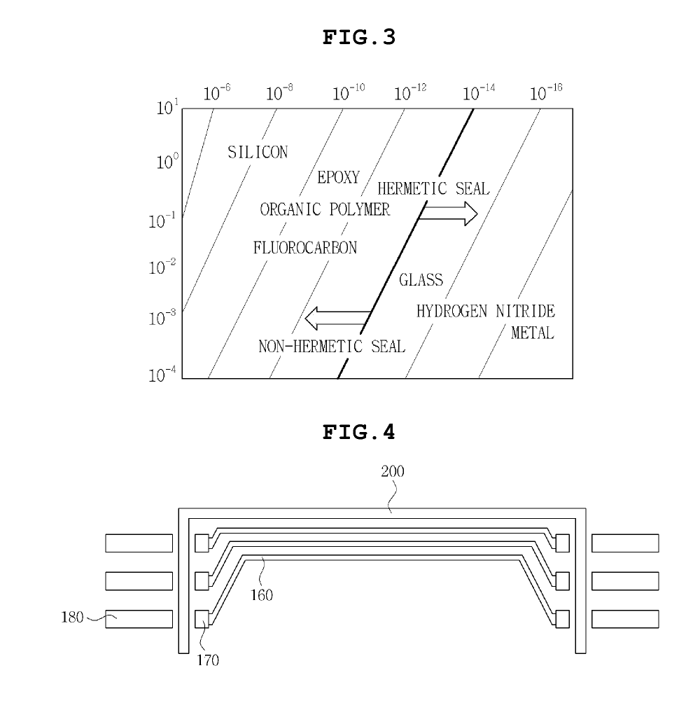

FIG. 3 is a graph illustrating transmittance depending on materials. Further, the inertial sensor module 100 needs a hermetic seal to prevent water, air, and the like from being introduced thereinto and therefore is formed on the substrate 10 for the lower cap by a WLP scheme. The WLP scheme uses two wafers of the substrate 10 for the lower cap and the substrate 30 for the upper cap at a wafer level and implements the hermetic seal of the inertial sensor module 100 and then dices the hermetic seal at a wafer level and therefore prevents air, dust, particles, moisture, and the like from sticking to or being introduced into the inertial sensor module 100 at the time of the dicing operation.

As illustrated in FIG. 3, the hermetic seal may be made of glass, silicon nitride, metal, and the like which have small transmittance. In particular, reliability of performance and performance of the hermetic seal may be more improved in the case in which metal is used than in the case in which the epoxy is used.

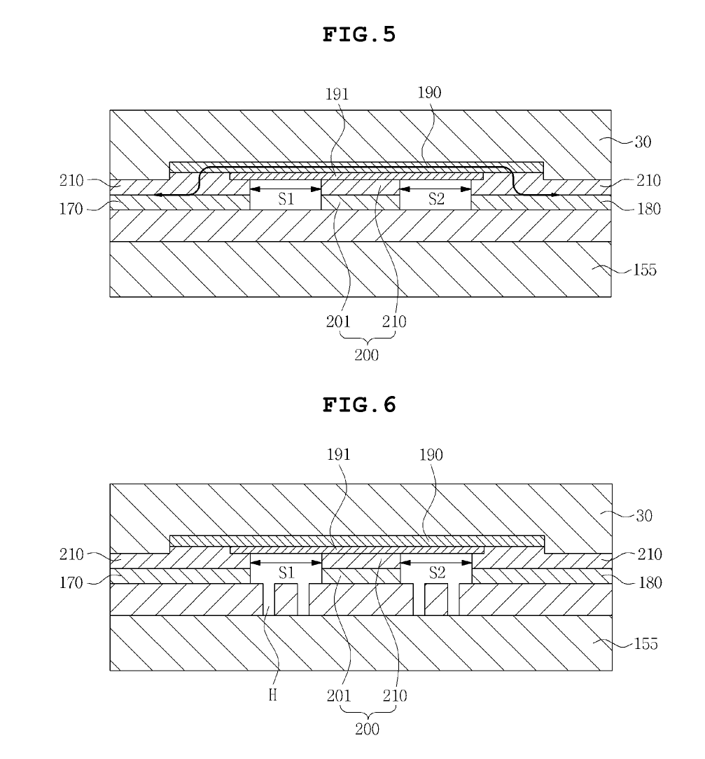

FIG. 4 is a diagram illustrating a hermetic seal and an electrode pad of FIG. 2 and FIG. 5 is an enlarged cross-sectional view of region “B” of FIG. 2. To use the hermetic seal 200 formed of metal, the inertial sensor module 100 includes a sensor main body 20 and the substrate 30 for the upper cap which are bonded to each other by metal bonding and a bridge electrode 190 insulated from and intersecting with the first and second electrode pads 170 and 180 spaced apart from each other and the hermetic seal 200 formed of metal to electrically connect the first and second electrode pads 170 and 180 to each other. Hereinafter, among the acceleration sensor 130 and the angular velocity sensor 150 included in the inertial sensor module 100, the angular velocity sensor 150 will be described for convenience.

As illustrated in FIGS. 4 and 5, the angular velocity sensor 150 includes the first and second electrode pads 170 and 180, the bridge electrode 190, and the hermetic seal 200 which are disposed at a bonded portion of the sensor main body 20 to be described below as including the frame 155 and the substrate 30 for the upper cap.

The first and second electrode pads 170 and 180 are formed on the frame 155, spaced apart from each other. The first electrode pad 170 is connected to a wiring 160 of the angular velocity sensor 150. Further, the bridge electrode 190 is interposed with a metal bonding sheet 210 used at the time of the metal bonding to be connected to the first and second electrode pads 170 and 180. Here, the wiring 160 is connected to a driving electrode or a sensing electrode (not illustrated) of the angular velocity sensor 150. Further, the first electrode pad 170 is connected to a distal end of the wiring 160.

The bridge electrode 190 is formed by being patterned within the substrate 30 for the upper cap and is formed to intersect with the hermetic seal 200, insulated therefrom.

That is, a bridge insulating pattern 191 is formed in a predetermined area on the bridge electrode 190 so that a predetermined area of the bridge electrode 190 is insulated. For example, the bridge insulating pattern 191 is formed on the bridge electrode 190 other than both ends of the bridge electrode 190 which are electrical connection portions of the first and second electrode pads 170 and 180, respectively. Therefore, as represented by an arrow illustrated in FIG. 5, the bridge electrode 190 is connected to the first and second electrode pads 170 and 180 by the bridge insulating pattern 191 but is insulated from the hermetic seal 200 intersecting therewith.

The hermetic seal 200 includes a metal pattern 201 which is formed on the frame 155 between the first and second electrode patterns 170 and 180 spaced apart from each other and a metal bonding sheet 210 interposed between the bridge insulating pattern 191 and the metal pattern 201.

Further, as the hermetic seal 200 is formed on the same plane as the first and second electrode pads 170 and 180, one side of the hermetic seal 200 is provided with the first electrode pad 170, having a first interval S1 and the other side of the hermetic seal 200 is provided with the second electrode pad 180, having a second interval S2.

FIG. 6 is a cross-sectional view illustrating a hermetic seal and an electrode pad of an angular velocity sensor according to another exemplary embodiment of the present disclosure. As illustrated in FIG. 6, the angular velocity sensor 150 may further include grooves H which are formed on the frame 155 of each of the first and second intervals S1 and S2.

Here, the first and second intervals S1 and S2 and the groove H are to prevent the hermetic seal 200 and the first and second electrode pads 170 and 180 from conducting to each other due to a flow of the metal bonding sheet 210 at the time of the metal bonding.

Hereinafter, a 6-axis sensor including the inertial sensor module according to the exemplary embodiment of the present disclosure will be described in more detail.

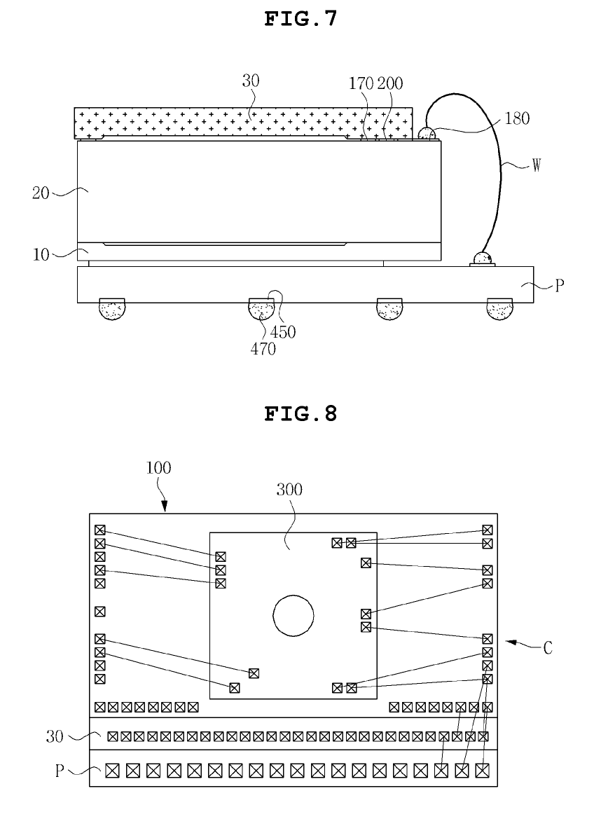

FIG. 7 is a cross-sectional view illustrating a 6-axis sensor according to an exemplary embodiment of the present disclosure. As illustrated in FIG. 7, the 6-axis sensor according to the exemplary embodiment of the present disclosure includes a printed circuit board (PCB) P, the inertial sensor module 100, and a wire W.

The PCB P is a wiring substrate for inputting and outputting a sensor signal and may include a solder ball pad 450 and a solder ball 470. Further, an in/out pad (not illustrated) for inputting and outputting the sensor signal may be formed.

The substrate 10 for the lower cap of the inertial sensor module 100 is to support and couple the sensor main body 20 to the PCB P while covering the sensor main body 20.

The inertial sensor module 100 is stacked on the PCB P and may sense the straight and angle motions. Here, the inertial sensor module 100 includes the second electrode pad 180 which is exposed by selectively removing a portion of the substrate 30 for the upper cap. For example, the substrate 30 for the upper cap is provided with an oxide film to be used as a mask at the time of dry etch before being bonded to the sensor main body 20 including the frame 155 and a portion of the substrate 30 for the upper cap is etched using the oxide film. Further, the etch automatically stops by the oxide film which is formed under the substrate 30 for the upper cap, and the oxide film is etched by the dry etch and thus the second electrode pad 180 is exposed.

Further, the inertial sensor module 100 is electrically connected to the PCB P by the exposed second electrode pad 180 and the wire W. Therefore, the sensing and driving signals of the inertial sensor module 100 are transferred to the PCB P.

Further, as described above, the 6-axis sensor according to the exemplary embodiment of the present disclosure may be formed in one module by stacking the inertial sensor module 100 on the PCB P and then packaging it as a whole.

Hereinafter, a 9-axis sensor including the inertial sensor module according to the exemplary embodiment of the present disclosure will be described in more detail.

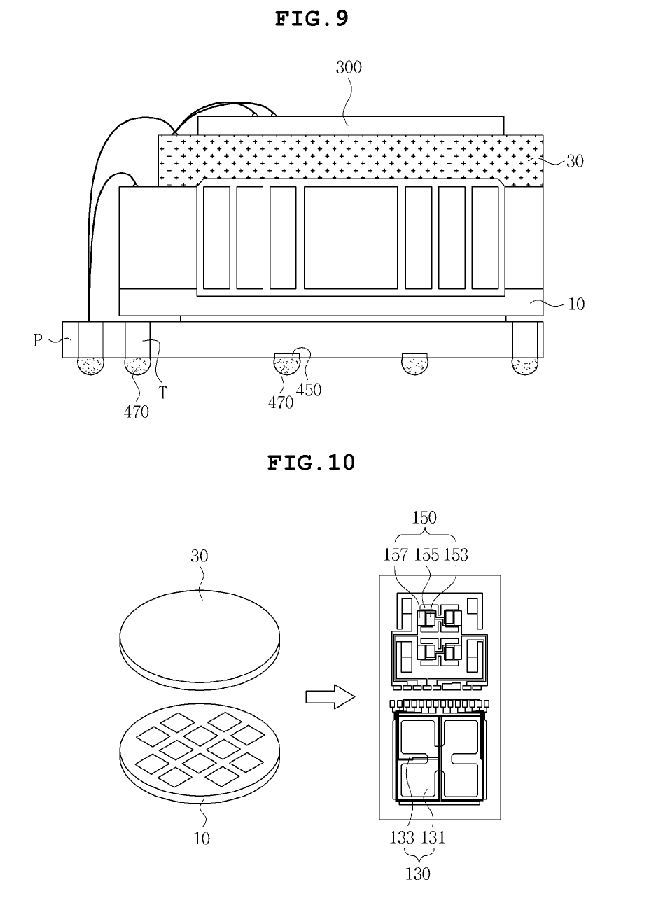

FIG. 8 is a plan view illustrating a 9-axis sensor according to an exemplary embodiment of the present disclosure and FIG. 9 is a cross-sectional view illustrating an angular velocity sensor and an earth magnetic field sensor in side ‘C’ of FIG. 8.

As illustrated in FIGS. 8 and 9, the 9-axis sensor according to the exemplary embodiment of the present disclosure includes the PCB P, the substrate 10 for the lower cap, the 6-axis inertial sensor module 100, and the 3-axis earth magnetic field sensor 300, and the substrate 10 for the lower cap is stacked on the PCB P, the 6-axis inertial sensor module 100 having the hermetic seal is directly formed on the substrate 10 for the lower cap by the WLP scheme, and the 3-axis earth magnetic field sensor 300 is bonded on the 6-axis inertial sensor module 100, thereby sensing straight, angle, and electromagnetic motions.

Further, as described above, the 9-axis sensor according to the exemplary embodiment of the present disclosure may be formed in one module by bonding the earth magnetic field sensor 300 on the 6-axis inertial sensor module 100 and then packaging it as a whole.

As described above, the 9-axis sensor according to the exemplary embodiment of the present disclosure is a 9-axis sensor which may sense an inertial force, that is, a straight line and an angle and a position, that is, the electromagnetic motion and overall calculates the information of various sensors such as the straight, angle, and electromagnetic motions to be utilized as the information required for functions of mobile devices, thereby providing more diverse and complex functions to users of mobile devices.

The PCB P may include a through hole T, a solder ball pad 450, and a solder ball 470.

The substrate 10 for the lower cap is a substrate which may have electrical wirings formed thereon in a horizontal/vertical direction and have hermetic seal bonding performed thereon and may be formed of LTCC, glass, interposer, ASIC provided with a through hole, silicon provided with vertical/horizontal wirings, and the like.

For example, the 9-axis sensor may be miniaturized and reduce power consumption by forming the 6-axis inertial sensor module 100 in the ASIC used as the substrate 10 for the lower cap and bonding the 3-axis earth magnetic field sensor 300 on the 6-axis inertial sensor module 100 to dispose the 9-axis sensor and the ASIC to be close to each other.

That is, a microelectromechanical systems (MEMS) and the ASIC are disposed to be close to each other, thereby improving the performance. Therefore, one of many matters which are to be considered by designers at the time of designing the MEMS comes from a necessity to operate an integrated circuit such as the ASIC and the MEMS together. Therefore, it is very important to package the components to be close to each other.

The earth magnetic field sensor 300 is the 3-axis sensor which is formed by the SIP scheme to measure strength of an earth's magnetic field and senses the electromagnetic motion. The earth magnetic field sensor 300 may be configured in a single chip using the MEMS technology. Further, the earth magnetic field sensor 300 may have a width of 1 m² to 1.5 m².

To implement the 3-axis sensor, the earth magnetic field sensor 300 may use three independent sensors such as a hall sensor, a magneto-resistance (MR) sensor, and a magneto-impedance (MI) sensor.

Here, the hall sensor, the MR sensor, and the MI sensor have a sensing direction in one direction and therefore are manufactured in one axis. For example, the earth magnetic field sensor 300 includes a first MR sensor sensing a magnetic field in an X-axis direction, a second MR sensor sensing a magnetic field in a Y-axis direction, and a hall sensor sensing a magnetic field in a Z-axis direction, in which the first and second MR sensors may be disposed on one side of the hall sensor to form a right angle to each other.

Hereinafter, a method for forming an inertial sensor module according to the exemplary embodiment of the present disclosure will be described in more detail.

FIG. 10 is a view illustrating a method for forming an inertial sensor module according to an exemplary embodiment of the present disclosure. As illustrated in FIG. 10, the method for forming a 6-axis inertial sensor module 100 according to the exemplary embodiment of the present disclosure forms the 3-axis acceleration sensor 130 and the 3-axis angular velocity sensor 150 on the substrate 10 for the lower cap using the WLP scheme.

The 6-axis inertial sensor module 100 needs the hermetic seal to prevent water, air, and the like from being introduced thereinto and therefore is formed on the substrate 10 for the lower cap by the WLP scheme. That is, a process of forming the 6-axis inertial sensor module 100 to which the hermetic seal is applied requires a wafer level bonding (WLB) process.

The WLP scheme uses two wafers of the substrate 10 for the lower cap and the substrate 30 for the upper cap at a wafer level and implements the hermetic seal of the 6-axis inertial sensor module 100 and then dices the hermetic seal at a wafer level and therefore prevents air, dust, particles, moisture, and the like from sticking to or being introduced into the 6-axis inertial sensor module 100 at the time of the dicing operation.

Hereinafter, a method for forming a hermetic seal and an electrode pad of an inertial sensor module according to the exemplary embodiment of the present disclosure will be described in more detail.

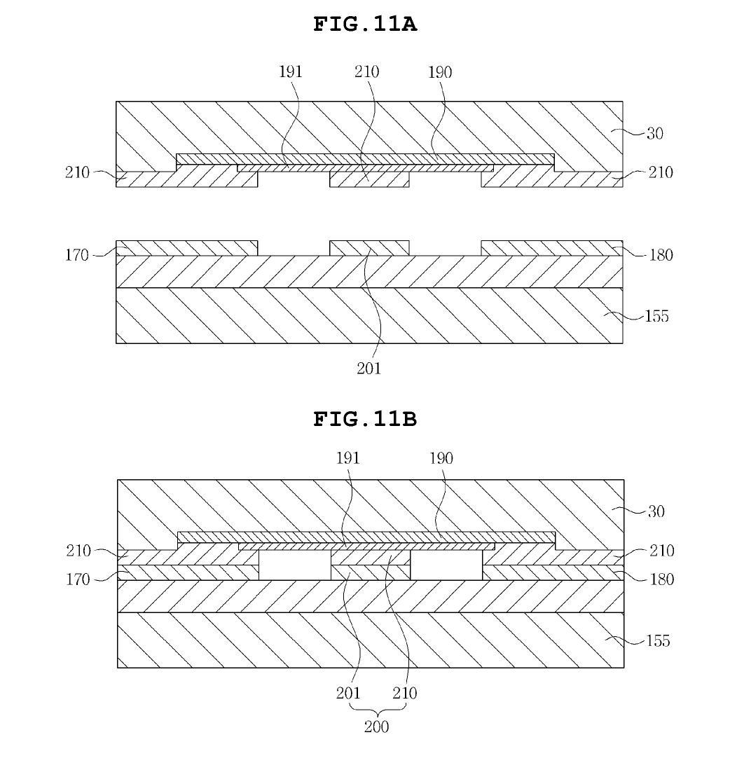

FIGS. 11A and 11B are cross-sectional views of a method for forming a hermetic seal and an electrode pad of FIG. 10. As illustrated in FIG. 11A, the bonded portion of the sensor main body 20 including the frame 155 and the substrate 30 for the upper cap is provided with the first and second electrode pads 170 and 180, the bridge electrode 190, and the metal pattern 201.

The metal patterns 201 which are components of the first and second electrode pads 170 and 180 and the hermetic seal 200 are formed on the frame 155, being spaced apart from each other.

Here, the metal patterns 201 are formed between the first and second electrode pads 170 and 180, being spaced apart from each other. Therefore, one side of the metal pattern 201 is provided with the first electrode pad 170, having the first interval 51 and the other side of the metal pattern 201 is provided with the second electrode pad 180, having the second interval S2. Further, the frames 155 of the first and second intervals S1 and S2, respectively, may be provided with the grooves H.

Further, the first electrode pad 170 is formed at a distal end of the wiring 160 so that it is electrically connected to the wiring 160 connected to the driving electrode or the sensing electrode of the angular velocity sensor 150.

The bridge electrode 190 is formed within the substrate 30 for the upper cap. Further, the bridge insulating pattern 191 is formed on an insulating layer of the bridge electrode 190 and is formed on the bridge electrode 190 between both ends by performing the patterning process which removes the insulating layers of both ends of the bridge electrode 190 which is an electrical connection portion of each of the first and second electrode pads 170 and 180.

As the method for forming first and second electrode pads 170 and 180, a metal pattern 201, and a bridge insulating pattern 191, etching, sputtering, or screen printing may be used.

As illustrated in FIGS. 11A and 11B, the first and second electrode pads 170 and 180, the bridge electrode 190, and the metal pattern 201 are formed at the bonded portion of the sensor main body 20 and the substrate 30 for the upper cap and then the metal bonding sheet 210 is interposed at each of the first and second electrode pads 170 and 180 and into the exposed bridge electrode 190 and at the metal pattern 201 and the bridge insulating pattern 191 to perform the metal bonding.

The bridge electrode 190 is electrically connected to the first and second electrode pads 170 and 180, respectively, by the metal bonding.

Further, since the bridge insulating pattern 191 is formed on the bridge electrode 190 between both ends of the bridge electrode 190, the hermetic seal 200 in which the metal pattern 201 and the metal bonding sheet 210 are stacked may be formed. Further, the bridge electrode 190 is insulated from the hermetic seal 200 formed of metal. Further, the bridge electrode 190 and the hermetic seal 200 may be formed to intersect with each other.

As described above, according to the inertial sensor module having a hermetic seal formed of metal and the multi-axis sensor employing the same according to the exemplary embodiment of the present disclosure, the hermetic seal is formed of metal, thereby improving the reliability of performance and the performance of the hermetic seal.

Further, the inertial sensor module may include the first and second electrode pads which are formed at both sides of the hermetic seal formed of metal, spaced apart from each other and the bridge electrode connecting between the first and second electrode pads and dispose the bridge electrode within the substrate for the upper cap, thereby reducing the thickness of the inertial sensor module.

Further, the 6-axis inertial sensor module having the hermetic seal formed of metal is formed on the substrate for the lower cap by the WLP scheme, thereby implementing the miniaturization and reducing the power consumption.

That is, according to the inertial sensor module having a hermetic seal formed of metal and the multi-axis sensor employing the same according to the exemplary embodiment of the present disclosure, the inertial sensor module is formed on the substrate for the lower cap by the WLP scheme to reduce the required area of the inertial sensor module, and thus has more reduced size compared to the inertial sensor module in which the 3-axis acceleration sensor and the 3-axis angular velocity sensor are formed by the SIP scheme, thereby achieving the miniaturization and improving the space utilization. Here, the inertial sensor module formed by the method for forming all the components by the SIP scheme has a limitation in reducing the size due to the required area for each sensor, and the like which are formed by the SIP scheme.

Further, according to the inertial sensor module having a hermetic seal formed of metal and the multi-axis sensor employing the same according to the exemplary embodiment of the present disclosure, the 6-axis inertial sensor module having the hermetic seal formed of metal is formed on the substrate for the lower cap by the WLP scheme and thus has the reduced number of manufacturing processes compared to the inertial sensor module formed by the SIP scheme, thereby being manufactured at low cost and produced in mass production to improving the productivity. Here, the inertial sensor module formed by the method for forming a 3-axis acceleration sensor and a 3-axis angular velocity sensor by the SIP scheme is manufactured in one module by mounting each manufactured sensor on the substrate such as the PCB by the die bonding, and the like, electrically connecting them by the wire bonding, and then packaging it with a metal can or plastic. The multi-axis sensor requires an operation of packaging components individually one by one to increase the package costs, and the like, thereby increasing the manufacturing costs of the package process of mounting and connecting each sensor and reducing the throughput of the package process to make mass production difficult.

Moreover, according to the inertial sensor module having a hermetic seal formed of metal and the multi-axis sensor employing the same according to the exemplary embodiment of the present disclosure, the inertial sensor module may be directly formed on the ASIC for the lower cap and the earth magnetic field sensor may be formed on the ASIC for the upper cap to dispose the ASIC and the inertial sensor module and the earth magnetic field sensor to be close to each other, thereby implementing the miniaturization and reducing the power consumption.

As set forth above, according to the exemplary embodiments of the present disclosure, the hermetic seal may be formed of metal to be able to improve the reliability of performance and the performance of the hermetic seal.

Further, the inertial sensor module may include the first and second electrode pads which are formed at both sides of the hermetic seal formed of metal, spaced apart from each other and the bridge electrode connecting between the first and second electrode pads and dispose the bridge electrode within the substrate for the upper cap, thereby reducing the thickness of the inertial sensor module.

In addition, the inertial sensor module having the hermetic seal formed of metal may be formed on the substrate for the lower cap by the WLP scheme and thus has a size smaller than that of the inertial sensor module which is formed by forming both of the 3-axis acceleration sensor and the 3-axis angular velocity sensor by each SIP scheme and then mounting them on the substrate, thereby improving the space utilization while achieving the miniaturization and reducing the number of manufacturing processes to improve the productivity.

Moreover, the inertial sensor module may be formed on the ASIC for the lower cap and the earth magnetic field sensor may be formed on the ASIC for the upper cap to dispose the ASIC and the inertial sensor module and the earth magnetic field sensor to be close to each other, thereby implementing the miniaturization and reducing the power consumption.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. An inertial sensor module, comprising:
a sensor main body including a plurality of wirings connected to any one of a driving electrode of a sensor and a sensing electrode of the sensor and formed on a substrate for a lower cap by a wafer level package (WLP) scheme to detect an inertial force;
a substrate for an upper cap bonded on the sensor main body to protect the sensor main body; and
a hermetic seal formed of metal isolated from the wiring and interposed into the sensor main body and the substrate for the upper cap by performing the bonding by metal bonding.

2. The inertial sensor module of claim 1, wherein the substrate for the lower cap includes an electrical wiring formed in horizontal/vertical directions and is formed of a material implementing hermetic seal bonding.

3. The inertial sensor module of claim 1, wherein the substrate for the lower cap is formed of any one of low temperature co-fired ceramic (LTCC), glass, interposer, application specific integrated circuit (ASIC), and silicon.

4. The inertial sensor module of claim 1, wherein the substrate for the upper cap and the substrate for the lower cap are each formed of ASIC.

5. The inertial sensor module of claim 1, wherein the sensor main body includes a 3-axis acceleration sensor and a 3-axis angular velocity sensor.

6. The inertial sensor module of claim 1, wherein the sensor main body includes:
a first pad formed on the sensor main body of the bonded portion and connected to a distal end of the wiring; and
a second pad formed on the sensor main body of the bonded portion, being spaced apart from the first pad.

7. The inertial sensor module of claim 1, wherein the substrate for the upper cap includes:
a bridge electrode formed within a lower portion of the substrate for the upper cap of the bonded portion; and
a bridge insulating pattern formed in a predetermined area on the bridge electrode to expose both ends of the bridge electrode, and
the bridge electrode intersects with the hermetic seal formed of metal and insulated by the bridge insulating pattern.

8. The inertial sensor module of claim 7, wherein the sensor main body includes a first pad connected to a distal end of the wiring and a second pad formed to be spaced apart from the first pad and
the bridge electrode and the first and second pads are connected to each other by having a metal bonding sheet used for the metal bonding interposed therebetween.

9. The inertial sensor module of claim 1, wherein the hermetic seal formed of metal is a stacked structure of a metal pattern formed on the sensor main body of the bonded portion and a metal bonding sheet used for the metal bonding.

10. The inertial sensor module of claim 8, wherein the hermetic seal formed of metal is interposed into the sensor main body and the bridge insulating pattern between the first and second pads.

11. A multi-axis sensor which is a 9-axis sensor, comprising:
a PCB;
a 6-axis inertial sensor module bonded on the PCB to sense an inertial force; and
a 3-axis earth magnetic field sensor bonded on the 6-axis inertial sensor module to sense a position, and
wherein the 6-axis inertial sensor module includes:
a sensor main body including a plurality of wirings connected to any one of a driving electrode of a sensor and a sensing electrode of the sensor and formed on a substrate for a lower cap by a WLP scheme to detect the inertial force;
a substrate for an upper cap bonded on the sensor main body to protect the sensor main body; and
a hermetic seal formed of metal isolated from the wiring and interposed into the sensor main body and the substrate for the upper cap by performing the bonding by metal bonding.

12. The multi-axis sensor of claim 11, wherein the substrate for the lower cap includes an electrical wiring formed in horizontal/vertical directions and is formed of a material implementing hermetic seal bonding.

13. The multi-axis sensor of claim 11, wherein the substrate for the upper cap and the substrate for the lower cap are each formed of ASIC.

14. The multi-axis sensor of claim 11, wherein the 3-axis earth magnetic field sensor is formed by a single-in-line package (SIP) scheme.

15. The multi-axis sensor of claim 11, wherein the sensor main body includes:
a first pad formed on the sensor main body of the bonded portion and connected to a distal end of the wiring; and
a second pad formed on the sensor main body of the bonded portion, being spaced apart from the first pad.

16. The multi-axis sensor of claim 11, wherein the substrate for the upper cap includes:
a bridge electrode formed within a lower portion of the substrate for the upper cap of the bonded portion; and
a bridge insulating pattern formed in a predetermined area on the bridge electrode to expose both ends of the bridge electrode, and
the bridge electrode intersects with the hermetic seal formed of metal and insulated by the bridge insulating pattern.

17. The multi-axis sensor of claim 16, wherein the sensor main body includes a first pad connected to a distal end of the wiring and a second pad formed to be spaced apart from the first pad and
the bridge electrode and the first and second pads are connected to each other by having a metal bonding sheet used for the metal bonding interposed therebetween.

18. The multi-axis sensor of claim 11, wherein the hermetic seal formed of metal is a stacked structure of a metal pattern formed on the sensor main body of the bonded portion and a metal bonding sheet used for the metal bonding.

19. The multi-axis sensor of claim 16, wherein the hermetic seal formed of metal is interposed into the sensor main body and the bridge insulating pattern between the first and second pads.
